(19) United States
(12) Patent Application Publication
(10) Pub. No.: US 2019/0245959 A1
(43) Pub. Date: Aug. 8, 2019

(54) Fingerprint Recognition Key, Mobile Terminal and Mobile phone

(71) Applicant: HUIZHOU TCL MOBILE COMMUNICATION CO., LTD, Huizhou (CN)

(72) Inventor: Hongbin ZHAN, Huizhou (CN)

(21) Appl. No.: 16/344,781

(22) PCT Filed: Oct. 24, 2017
(86) PCT No.: PCT/CN2017/107419

§ 371 Date: Apr. 24, 2019

(30) Foreign Application Priority Data
Nov. 1, 2016 (CN) 201610942631.4

(51) Int. Cl. H04M 1/02; H04M 1/23; H04L 9/32; G06K 9/00; H05K 1/02

(52) U.S. Cl. CPC H04M 1/0277; H04M 1/23; H05K 2201/2018; G06K 9/00013; H05K 1/0283; H04L 9/3231

(57) ABSTRACT

A fingerprint recognition key including a fingerprint recognition module and a flex-rigid printed circuit board is described. The fingerprint recognition module is arranged on one side surface of a first rigid circuit board area of the flex-rigid printed circuit board. A circuit of the fingerprint recognition module is connected to a flexible circuit area of the flex-rigid printed circuit board. A tact switch connected to the flexible circuit area is arranged at a position, corresponding to the position of the fingerprint recognition module, on the other side surface of the rigid circuit board area. A circuit of the flexible circuit area is connected to a circuit of a second rigid circuit board area of the flex-rigid printed circuit board. A mobile terminal and a mobile phone, both including said fingerprint recognition key, are also described.

### TECHNICAL FIELD

The present disclosure relates to the fingerprint recognition technology, particularly to a fingerprint identification key, a mobile terminal and a cellular phone integrated with a fingerprint identification key.

### BACKGROUND

At present, as people's requirements for privacy security are getting higher and higher, many manufacturers of mobile terminals use privacy security as an important selling point when they promote their products. As a result, basically all mobile terminals are equipped with a fingerprint recognition function. The design of the existing fingerprint recognition key mainly uses a flexible circuit board and a reinforcing steel piece to be a fingerprint sensor, and further includes a dome switch and a wiring carrier. The reinforcing steel piece is only used for locally reinforcing the flexible circuit board to prevent the flexible circuit board from being bent. Since the reinforcing steel piece is provided only for the purpose of reinforcing the flexible circuit board to prevent it from being bent, the reinforcing steel piece itself cannot withstand a great number of presses. As a result, after the dome switch is pressed many times, the reinforcing steel piece may be deformed due to undesirable and weak strength.

### SUMMARY

To overcome the deficiencies of the existing technology, the present disclosure provides a fingerprint recognition key, a mobile terminal, and a mobile phone, which improve the strength of a board carrying a fingerprint recognition module and a dome switch.

In one aspect of the present disclosure, a fingerprint recognition key including a fingerprint recognition module and a flexible and rigid combination board is provided. In an embodiment, the fingerprint recognition module can be arranged on a first side surface in a first rigid circuit board area of the flexible and rigid combination board, a circuit of the fingerprint recognition module can be connected to a flexible circuit area of the flexible and rigid combination board, a dome switch connected to the flexible circuit area is provided in a position corresponding to the position of the fingerprint recognition module on a second side surface of the rigid circuit board area which is opposite to the first side surface of the rigid circuit board area, a circuit of the flexible circuit area can be connected to a circuit of a second rigid circuit board area of the flexible and rigid combination board.

In another embodiment, the dome switch can be arranged in a central position of the fingerprint recognition module.

In yet another embodiment, the shape and size of the first rigid circuit board area may match the shape and size of the fingerprint recognition module.

In yet another embodiment, the fingerprint recognition module comprises an annular frame arranged on a surface of the first rigid circuit board area, a fingerprint sensor arranged in the annular frame, and a glass plate which covers the fingerprint sensor and is embedded in the annular frame.

In yet another embodiment, the position of the switch on the dome switch can be covered by a metal spring piece.

In another aspect of the present disclosure, a mobile terminal comprising a fingerprint recognition key described above is provided.

In an embodiment, the fingerprint recognition key may be arranged on a front side or a back side of the mobile terminal, or on an edge of a periphery of the mobile terminal.

In yet another aspect of the present disclosure, a mobile phone comprising a fingerprint recognition key described above is provided.

In an embodiment, the fingerprint recognition key may be arranged on a front side or a back side of the mobile phone, or on an edge of a periphery of the mobile phone.

Compared with the existing technology, the present invention replaces the reinforcing steel piece in a fingerprint recognition key with a flexible and rigid combination board. The flexible and rigid combination board itself has good strength; it does not need a reinforcing steel sheet for reinforcement. Advantageously, the fingerprint recognition module and the dome switch are respectively disposed on two opposing sides of one rigid circuit board area on the flexible and rigid combination board, which can save space. In addition, the circuit of the fingerprint identification module and the circuit of the dome switch are both connected to the circuit of a flexible circuit area, and the fingerprint recognition key is further connected to the main board of a mobile phone through another rigid circuit board. In this way, the present invention not only has a reliable structure, but also improves the rigidity of the fingerprint recognition key.

### BRIEF DESCRIPTION OF THE DRAWINGS

FIG. 1 illustrates a schematic view of the structure of a fingerprint recognition key according to an exemplary embodiment of the present invention.

### DETAILED DESCRIPTION

The present invention will be further described in detail below with reference to the accompanying drawings and exemplary embodiments. It should be understood that exemplary embodiments described herein are for illustrative purposes only. The exemplary embodiments are not intended to limit the scope of the claimed invention in any way.

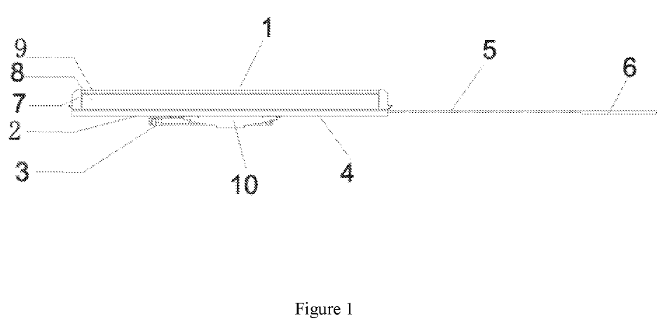

FIG. 1 illustrates a schematic view of the structure of a fingerprint recognition key according to an exemplary embodiment of the present invention. As shown in FIG. 1, the present invention provides a fingerprint recognition key, which includes a fingerprint recognition module 1 and a dome switch 3, both the fingerprint recognition module 1 and the dome switch 3 are carried on a flexible and rigid combination board 2. The flexible and rigid combination board 2 includes a first rigid circuit board area 4, a second rigid circuit board area 6 and a flexible circuit area 5 connecting the first rigid circuit board area 4 and the second rigid circuit board area 6. The fingerprint recognition module 1 includes an annular frame 7 arranged on one side surface of the first rigid circuit board area 4, a fingerprint sensor 8 arranged in the annular frame 7, and a cover plate 9 which covers the fingerprint sensor 8 and is embedded in the annular frame 7. The fingerprint recognition module 1 replaces the structure of a flexible circuit board and a reinforcing steel piece of a conventional fingerprint recognition key with the first rigid circuit board area 4. Since the first rigid circuit board area 4 has the rigidity of the rigid circuit board, it is able to withstand a great number of presses, in addition, both its front side and back side can be patched. Thus, when compared with the conventional reinforcing steel sheet structure, it can avoid the problem that the reinforcing steel sheet can be easily deformed. Furthermore, the arrangements and structures of the remaining components of the fingerprint recognition module 1 of the present invention are the same as those in a fingerprint recognition module 1 in the existing technology.

In an embodiment, a dome switch 3 can be disposed in a position corresponding to the position of the fingerprint recognition module 1 on another side surface of the first rigid circuit board area 4 opposite to the side surface on which the fingerprint recognition module 1 is disposed. In addition, the position of a switch on the dome switch 3 can be covered by a metal spring piece 10.

In another embodiment of the present invention, a circuit of the fingerprint recognition module 1 and a circuit of the dome switch 3 both may be connected to circuits of the flexible circuit area 5, such that the signals can be sent to the second rigid circuit board area 6. In addition, the second rigid circuit board area 6 may be further provided with a board-to-board connector that connects to a main control board (the main board of the product) for communication with the main control board.

In yet another embodiment of the present invention, the cover plate 9 may be made of sapphire, a coated material, ceramic or glass.

The present invention further discloses a mobile terminal and a mobile phone, both of which adopt the fingerprint recognition key of the present invention. The fingerprint recognition key is connected with the main board of the product through a board-to-board connector provided on the second rigid circuit board area 6, so as to achieve the function of fingerprint recognition. The fingerprint recognition key of the present invention can be disposed on the front side of the mobile terminal or mobile phone having a display screen (touch screen), the back side having the camera, or on an edge (edge frame) of the periphery of the device.

Although the present invention has been shown and described with reference to specific embodiments, a person of ordinary skill in the art would appreciate that various changes in form and detail may be made without departing from the spirit and scope of the present invention defined by appended claims or equivalents.

1. A fingerprint recognition key, comprising a fingerprint recognition module and a flexible and rigid combination board, wherein:
the fingerprint recognition module is arranged on a first side surface in a first rigid circuit board area of the flexible and rigid combination board,
a circuit of the fingerprint recognition module is connected to a flexible circuit area of the flexible and rigid combination board,
a dome switch connected to the flexible circuit area is disposed in a position corresponding to a position of the fingerprint recognition module on a second side surface of the rigid circuit board area opposite the first side surface,
a circuit of the flexible line area is connected to a circuit of a second rigid circuit board area of the flexible and rigid combination board,
the dome switch is arranged in a central position of the fingerprint recognition module, a shape and size of the first rigid circuit board area match a shape and size of the fingerprint recognition module, and a position of a switch on the dome switch is covered by a metal spring piece.

2. The fingerprint recognition key according to claim 1, wherein the fingerprint recognition module comprises an annular frame arranged on a surface of the first rigid circuit board area, a fingerprint sensor arranged in the annular frame, and a cover plate which covers the fingerprint sensor and is embedded in the annular frame.

3. A mobile terminal comprising a fingerprint recognition key, wherein the fingerprint recognition key comprises a fingerprint recognition module and a flexible and rigid combination board, wherein the fingerprint recognition module is arranged on a first side surface in a first rigid circuit board area of the flexible and rigid combination board, a circuit of the fingerprint recognition module is connected to a flexible circuit area of the flexible and rigid combination board, a dome switch connected to the flexible circuit area is disposed in a position corresponding to a position of the fingerprint recognition module on a second side surface of the rigid circuit board area opposite to the first side surface, a circuit of the flexible circuit area is connected to a circuit of a second rigid circuit board area of the flexible and rigid combination board.

4. The mobile terminal according to claim 3, wherein the fingerprint recognition key is arranged on a front side or a back side of the mobile terminal, or on an edge of a periphery of the mobile terminal.

5. The mobile terminal according to claim 3, wherein the dome switch is arranged in a central position of the fingerprint recognition module.

6. The mobile terminal according to claim 3, wherein a shape and size of the first rigid circuit board area match a shape and size of the fingerprint recognition module.

7. The mobile terminal according to claim 3, wherein the fingerprint recognition module comprises an annular frame arranged on a surface of the first rigid circuit board area, a fingerprint sensor arranged in the annular frame, and a cover plate which covers the fingerprint sensor and is embedded in the annular frame.

8. The mobile terminal according to claim 7, wherein a position of a switch on the dome switch is covered by a metal spring piece.

9. A mobile phone comprising a fingerprint recognition key, wherein the fingerprint recognition key comprises a fingerprint recognition module and a flexible and rigid combination board, wherein the fingerprint recognition module is arranged on a first side surface in a first rigid circuit board area of the flexible and rigid combination board, a circuit of the fingerprint recognition module is connected to a flexible circuit area of the flexible and rigid combination board, a dome switch connected to the flexible circuit area is disposed in a position corresponding to a position of the fingerprint recognition module on a second side surface of the rigid circuit board area opposite to the first side surface, a circuit of the flexible circuit area is connected to a circuit of a second rigid circuit board area of the flexible and rigid combination board.

10. The mobile phone according to claim 9, wherein the fingerprint recognition key is arranged on a front side or a back side of the mobile phone, or on an edge of a periphery of the mobile phone.

11. The mobile phone according to claim 9, wherein the dome switch is arranged in a central position of the fingerprint recognition module.

12. The mobile phone according to claim 9, wherein the fingerprint recognition module comprises an annular frame arranged on a surface of the first rigid circuit board area, a fingerprint sensor arranged in the annular frame, and a cover plate which covers the fingerprint sensor and is embedded in the annular frame.

13. The mobile phone according to claim 12, wherein a position of a switch on the dome switch is covered by a metal spring piece.

14. The mobile phone according to claim 9, wherein a shape and size of the first rigid circuit board area match a shape and size of the fingerprint recognition module.

15. The fingerprint recognition key according to claim 2, wherein the cover plate comprises a material selected from the group consisting of a sapphire, a coated material, a ceramic and a glass.

16. The mobile terminal according to claim 7, wherein the cover plate comprises a material selected from the group consisting of a sapphire, a coated material, a ceramic and a glass.

17. The mobile phone according to claim 12, wherein the cover plate comprises a material selected from the group consisting of a sapphire, a coated material, a ceramic and a glass.

18. The fingerprint recognition key according to claim 1, wherein the second rigid circuit board area of the flexible and rigid combination board further comprises a board-to-board connector connecting to a main control board of a mobile terminal.

19. The mobile terminal according to claim 3, wherein the second rigid circuit board area of the flexible and rigid combination board further comprises a board-to-board connector connecting to a main control board of the mobile terminal.

20. The mobile phone according to claim 7, wherein the second rigid circuit board area of the flexible and rigid combination board further comprises a board-to-board connector connecting to a main control board of the mobile phone.
